(19) United States
(12) Patent Application Publication
(10) Pub. No.: US 2021/0182704 A1
(43) Pub. Date: Jun. 17, 2021

(54) Surface Detection Based on Vehicle Motion Patterns

(71) Applicant: NAVMATIC, INC., Palo Alto, CA (US)

(72) Inventors: Boaz Mamo, Sunnyvale, CA (US); Xiaolei Mao, Sunnyvale, CA (US); Andrew Hazlett, San Jose, CA (US); Nathan James Pahucki, Algarrobo (CL)

(21) Appl. No.: 16/860,502

(22) Filed: Apr. 28, 2020

Related U.S. Application Data
(60) Provisional application No. 62/948,096, filed on Dec. 13, 2019.

(51) Int. Cl. G06N 5/04; G06F 17/14; G06F 16/29; G01B 17/08; G01C 21/34

(52) U.S. Cl. CPC G06N 5/04; G06F 17/142; G01C 21/3407; G01B 17/08; G06F 16/29

(57) ABSTRACT

A system and method are disclosed for a system determining surface types using motion patterns. In an embodiment, the system receives inertial measurements from a sensor of a vehicle operating on a surface of an unknown surface type. The system generates a prediction of a type of the surface based on the inertial measurements. In some embodiments, the system generates the prediction by performing a fast Fourier transform (FFT) operation on the inertial measurements to generate a set of frequency bins that reflect surface features. In other embodiments, the system generates the prediction by inputting the inertial measurements into a trained machine learning model configured to generate the prediction of the surface type. The system provides for display data representing the prediction on a user device. The system may also determine the speed and/or geographic location of the vehicle using the inertial measurements and the surface type prediction.

### CROSS-REFERENCE TO RELATED APPLICATION

This application claims benefit of U.S. Provisional Patent Application Ser. No. 62/948,096 filed Dec. 13, 2019, which is incorporated by reference.

### TECHNICAL FIELD

The disclosure generally relates to the field of signal processing, and in particular to the automatic detection of surface types.

### BACKGROUND

In response to increased incidents between pedestrians and micro-mobility vehicle operators, many municipalities no longer allow operation of certain micro-mobility vehicles on sidewalks. For example, in many municipalities, motorists are no longer allowed to operate bicycles and scooters on sidewalks. However, laws surrounding micro-mobility vehicle operation are often unenforceable due to the resource allocation required by governing agencies. Further, current location estimation systems are often not accurate enough to determine where within a roadway a vehicle is operating, nor are they able to determine the types of surfaces the vehicle is operating on. In addition, systems do not exist that enable governing agencies to analyze the aggregate behavior and motion patterns of micro-mobility operators. Therefore, pedestrian injury incident rates are likely to rise as micro-mobility vehicles become increasingly popular.

### SUMMARY

Systems and methods are disclosed herein for a surface detection system configured to detect surfaces using motion patterns. The surface detection system determines a type of surface a vehicle is operating on using the output signals from one or more sensors on a vehicle or device of a user. In addition to determining surface types, the surface detection system may similarly determine vehicle speed and location. The surface detection system identifies the location of a vehicle more accurately than current location estimation systems by identifying where within a roadway a vehicle is operating. For example, the surface detection system can determine whether a user is operating a micro-mobility scooter in a bike lane or on a sidewalk. Using the determined surface type, speed, and location of a vehicle, the surface detection system may analyze the behavior of a vehicle operator and/or the aggregate motion patterns of operators within various jurisdictions. Governing agencies and other interested entities (e.g., insurance agencies) may use this analysis to enforce traffic laws, set insurance rates, and better regulate operator behavior.

In an embodiment, a surface detection system receives inertial measurements from a sensor of a vehicle operating on a surface of an unknown surface type. The surface detection system generates a prediction of a type of the surface based on the inertial measurements. In some embodiments, the surface detection system generates the prediction by performing a fast Fourier transform (FFT) operation on the inertial measurements to generate a set of frequency bins that reflect surface features. In these embodiments, the surface detection system identifies a surface pattern based on the set of frequency bins. The surface detection system generates the prediction of the type of the surface based on the identified surface pattern. In other embodiments, the surface detection system generates the prediction by inputting the inertial measurements into a trained machine learning model that is configured to generate the prediction of the type of the surface based on the inertial measurements. The surface detection system provides for display, on a user device of a user, data representing the prediction of the type of surface. The prediction may include a probability of a surface type for each of a plurality of surface types, a classification of a surface type, and the like. The surface detection system may generate a rider report for the user based on the prediction. The surface detection system may then provide the rider report for display on the user device of the user.

In some embodiments, the surface detection system identifies the location of the vehicle based on the predicted surface type. The surface detection system may do this by receiving, from a receiver, an approximate location of the vehicle to identify a geographic area in which the vehicle is located. The surface detection system identifies surface types and locations of surfaces within the geographic region. The surface detection system may then refine the location approximation of the vehicle based on a combination of the predicted surface type the vehicle is operating on, the identified surface types within the geographic region, and the locations of the surfaces of the identified surface types within the geographic region.

In addition, the surface detection system may identify the speed of the vehicle using the inertial measurements. For example, the surface detection system may determine the speed of the vehicle by comparing the motion patterns associated with the vehicle and known motion patterns of vehicles operating on similar surface types at known speeds. Using the determined speed of the vehicle, the surface detection system may determine whether the motorist operating the vehicle is violating traffic laws, whether there are slowdowns due to vehicle congestion, and the like.

### A BRIEF DESCRIPTION OF THE DRAWINGS

FIG. 1 illustrates a system environment of a surface detection system, according to one embodiment.

FIG. 2 is a block diagram of the surface detection system, according to one embodiment.

FIG. 3 illustrates variations in surface types detectable by the surface detection system, according to one embodiment.

FIG. 4 illustrates a time domain representation of sensor output signals, according to one embodiment.

FIG. 5 is flow chart illustrating a method of predicting a surface type, according to one embodiment.

FIG. 6 is a flow chart illustrating a method of predicting a surface type using a fast Fourier transform operation, according to one embodiment.

FIG. 7 is a flow chart illustrating a method of training a machine learning model to predict a surface type, according to one embodiment.

The figures depict various example embodiments of the present technology for purposes of illustration only. One skilled in the art will readily recognize from the following description that other alternative embodiments of the structures and methods illustrated herein may be employed without departing from the principles of the technology described herein.

### DETAILED DESCRIPTION

### System Overview

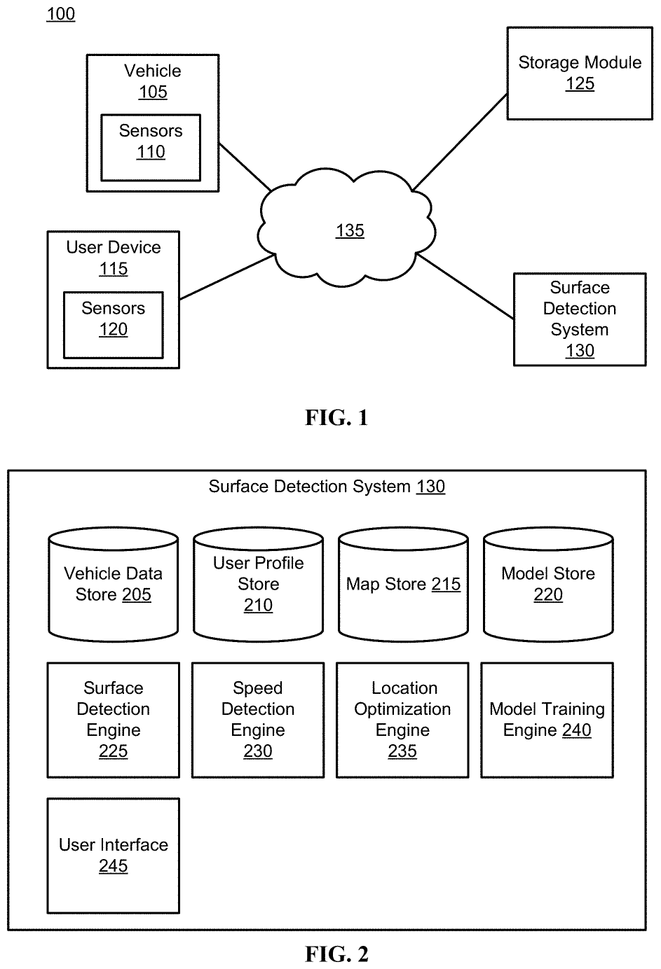

FIG. 1 illustrates a system environment 100 of a surface detection system 130, according to one embodiment. The system environment 100 shown by FIG. 1 includes a vehicle 105, a user device 115, a storage module 125, a surface detection system 130, and a network 135. In alternative configurations, different and/or additional components may be included in the system environment 100.

A vehicle 105 may be any appropriate means for transportation, including an automated scooter, car or automobile, bicycle, motorcycle, skateboard, or any other ground-based transportation entity. A user device 115 is a computer system, such as a desktop or a laptop computer. Alternatively, a user device 115 may be a device having computer functionality, such as a mobile telephone, a smartphone, tablet, smart watch, or another suitable device.

Sensors may include one or more of an accelerometer, altimeter, inertial measurement unit, gyroscope, magnetometer, another suitable type of sensor that detects motion, or some combination thereof. In some embodiments, sensors may also include one or more imaging sensors, such as a camera or any other device capable of capturing images of an environment of a user. In some embodiments, sensors are coupled to or embedded within a vehicle 105 of a user. For example, the sensors 110 of vehicle 105 may be coupled to a frame, exterior surface, and/or interior surface of the vehicle 105. In some embodiments, sensors 120 may be coupled to, or embedded within, a user device 115 of a user. For example, sensors 120 may be coupled to a wearable device of the user, smart phone of the user, tablet of the user, and the like. Sensor output signals measure the bumps and bounces a vehicle experiences when the vehicle moves over a particular surface type. The patterns detected within the measurements of the bumps and bounces are used by the surface detection system 130 to infer surface types.

The surface detection system 130 may remotely access data stored in a storage module 125. Data stored in the storage modules may include, but is not limited to, sensor output signals, vehicle data, user device data, user data, jurisdiction data, and map data. Map data may include a location of each of a plurality of types of surfaces within a geographic area. The storage module 125 may also store models used by the surface detection system 130 to determine a surface type of a surface, a speed of a vehicle, and/or a refined location approximation of a vehicle or user. Models may include fast Fourier Transform (FFT) operations, machine learning models (e.g., neural networks, decision trees, random forest classifiers, logistic regressions, etc.), computer vision models, and the like. Additionally, the storage module 125 may store training data used by the surface detection system 130 to train one or more models.

The surface detection system 130 determines a surface type of a surface on which a vehicle is operating. The surface detection system 130 does this using sensor output signals generated by sensors coupled to a vehicle 105 and/or user device 115 of a user. Using the determined surface types, the surface detection system 130 may refine a location approximation of a user and/or detect a speed of a vehicle 105. The surface detection system 130 may generate information about a user's driving behavior using a combination of the determined surface type, location, and speed. Information may be used by a user of the vehicle to track fitness metrics, such as length of ride, average speed, average altitude change, cadence, power output, frequency of vehicle use, distance traveled, and the like. Information may also be used by governing agencies to determine whether the user violated traffic laws, insurance companies to set premiums, internal or external navigations systems to refine location information, wearable technology entities to monitor user activity, and the like. In some embodiments, the surface detection system 130 uses the information to generate a rider report. A rider report may be any analysis of rider behavior. Analysis may be performed in real-time and/or at the end of the trip. Rider reports may be accessed by the user, juristic entities, and other interested parties.

The network 135 facilitates communication between the surface detection system 130, the vehicle 105, user device 115, and storage module 125. The network 135 may be any wired or wireless local area network (LAN) and/or wide area network (WAN), such as an intranet, an extranet, or the Internet. In various embodiments, the network 135 uses standard communication technologies and/or protocols. Examples of technologies used by the network 135 include Ethernet, 802.11, 3G, 4G, 802.16, or any other suitable communication technology. The network 135 may use wireless, wired, or a combination of wireless and wired communication technologies. Examples of protocols used by the network 135 include transmission control protocol/Internet protocol (TCP/IP), hypertext transport protocol (HTTP), simple mail transfer protocol (SMTP), file transfer protocol (TCP), or any other suitable communication protocol. Data exchanged over the network 135 may be represented using any suitable format, such as hypertext markup language (HTML), extensible markup language (XML), or JavaScript Object Notation (JSON). In some embodiments, all or some of the communication links of the network 135 may be encrypted using any suitable technique or techniques, such as secure sockets layer (SSL) and/or transport layer security (TLS).

FIG. 2 is a block diagram of an architecture of the surface detection system 130, according to one embodiment. In the embodiment shown in FIG. 2, the surface detection system 130 includes a vehicle data store 205, a user profile store 210, a map store 215, a model store 220, a surface detection engine 225, a speed detection engine 230, a location optimization engine 235, a model training engine 240, and a user interface 245. In other embodiments, the surface detection system 130 includes different and/or additional elements. In addition, the functions may be distributed among the elements in a different manner than described.

The surface detection system 130 maintains vehicle data and user device data in the vehicle data store 205. Vehicle data and user device data stored in the vehicle data store 205 may include local copies of some or all of the data stored in the storage module 125. Vehicle data may include information about the number and types of sensors coupled to and/or embedded within a vehicle 105 (“vehicle sensors”), vehicle specifications, including wheel type, axle type, wheel base, and the like. User device data may include data about the number and types of sensors coupled to the user device 115 (“device sensors”), device specifications, and the like. Data may also include output from the one or more vehicle sensors 110 and/or device sensors. Sensor output may include inertia, acceleration, pose, orientation, altitude, force, angular momentum measurements, and corresponding changes in measurements over time. In some embodiments, vehicle data and user device data may be stored remotely in the storage module 125 and accessed by the surface detection system 130 via the network 135.

The surface detection system 130 maintains user data in the user profile store 210. Alternatively, user data may be stored remotely in the storage module 125 and accessed by the surface detection system 130 via the network 135. In some embodiments, the user profile store 210 maintains a profile for each user associated with a vehicle 105 or user device 115 in communication with the surface detection system 130. Each user profile may include data that describes one or more attributes of a user. Examples of data may include biographic information, demographic information, geographic information, driving history, health data, and the like. User data may be added, deleted, and/or edited through the user interface 245 of the surface detection system 130. User data may also be generated by the surface detection system 130 based on data gathered during vehicle operation. Examples of data generated by the surface detection system 130 may include average speed, average speed over and/or under a speed limit, length and distance of trip, frequency of vehicle use, location of ride, and the like. The surface detection system 130 may aggregate user data into a rider report. In some embodiments, user data may be subject to privacy settings set by a user via the user interface 245.

The surface detection system 130 maintains map data and jurisdiction data in the map store 215. Map data may correspond to different geographical areas and include topographical information, general reference information, and the like. Map data may also include the configuration and types of street elements, including roadways, sidewalks, curbs, parkways, highways, medians, and the like. Map data may also include information about the specifications of street elements, including lane width, curb radius, median opening, and materials of corresponding elements (e.g., concrete, asphalt, cobblestone, brick, packed dirt, etc.). Map data may also include weather and climate data, which may affect the interaction of vehicle wheels with surfaces.

Jurisdiction data may include state and/or local laws of different geographic areas, such as traffic laws and speed laws defined in a vehicle code of a jurisdiction. Examples of traffic laws may include laws surrounding the operation of motorized scooters in car and/or bike lanes, operation of bicycles and skateboards on a sidewalk, and the like. Jurisdiction data may also include information about general and maximum speed limits of different road types and geofences, such as highways, neighborhood roads, school zones, and the like. In some embodiments, map data and jurisdiction data may be stored remotely in the storage module 125 and accessed by the surface detection system 130 via the network 135.

The surface detection system 130 maintains one or models and training data in the model store 220. Models may be used to determine a surface type of a surface, determine a speed of a vehicle, and/or refine a location approximation of a vehicle or user. Models may include FFT operations, machine learning models (e.g., neural networks, decision trees, random forest classifiers, logistic regressions, etc.), online learning models, reinforcement learning models, computer vision models, and the like.

Training data includes sensor output signals from vehicle sensors 110 and device sensors 120 captured while a vehicle is operating on known surfaces. These sensor output signals are associated with a label indicating the type of surface the vehicle and/or user device was operating on, and may include an indication of the speed and location of the vehicle/user device during measurement, vehicle/device specifications, road conditions during measurement, and the like. For example, training data may include a set of inertial measurements, and each inertial measurement may be associated with a label indicating the surface type of the surface on which a corresponding vehicle was operating, the location of the vehicle, and the speed of the vehicle at the time of measurement.

Training data may also include candidate surface patterns. A surface pattern is composed of a set of frequency bins that represent surface features. A candidate surface pattern is a surface pattern generated from the output signals of vehicle sensors 110 and/or device sensors 120 of a vehicle and/or user device operating on a known surface. A candidate surface pattern may be a single surface pattern generated from one or more sensors. Alternatively, or additionally, a candidate surface pattern may be a median, average, minimum, maximum, etc., of multiple surface patterns. For example, a candidate surface pattern may be an average of two or more surface patterns generated using sensor output signals from the same or similar vehicles operating on the same surface type at the same location and/or at the same speed. Candidate surface types include a combination of a label indicating the type of surface, vehicle specifications, road conditions, and parameters used to generate the candidate surface pattern. In some embodiments, models and/or training data may be stored remotely in the storage module 125 and accessed by the surface detection system 130 via the network 135.

The surface detection engine 225 determines the surface type of a surface a vehicle is operating on. Surface types determined by the surface detection engine 225 may be based on the material of the surface (e.g., concrete, gravel, asphalt), the intended use of the surface (e.g., bike lane, highway, sidewalk), and or a combination thereof (e.g., a gravel footpath, an asphalt bike lane, a concrete sidewalk). Further, in some embodiments, the surface detection engine 225 is able detect street elements of the surface, such as a curb, a pothole, a tactile pavement, and the like.

The surface detection engine 225 determines the surface type of a surface using sensor output, such as inertial measurements, received from the one or more vehicle sensors 110 and/or device sensors 120. Sensor output signals reflect the properties of the surface, including the physical and mechanical properties of the surface a vehicle is driving on. For example, the sensor output signals generated while a vehicle is operating on a sidewalk are different than the sensor output signals generated while the vehicle is operating on a bike lane. This may occur because sidewalks and bike lands are often constructed from different materials (e.g., concrete and asphalt, respectively), which have different microtextures and macrotextures. Additionally, sidewalks often have regularly spaced expansion joints and bike lanes often have directional markings made of thermoplastic resin, both of which may affect sensor output signals.

In some embodiments, the surface detection engine 225 determines the surface type of a surface via frequency domain spectrum analysis. In these embodiments, the surface detection engine 225 performs FFT operations on sensor output signals to identify a surface type. For example, FFT operations may be performed on inertial measurements from vehicle sensors 110 to generate frequency bins that represent features from the surface the vehicle is operating on. The collection of features is referred to as a surface pattern and is compared to candidate surface types and candidate surface patterns stored in the model store 220. The surface detection engine 225 determines the surface type of the unknown surface based on the comparison. In some embodiments, the surface detection engine 225 determines the surface type if there is a threshold number of similar characteristics between the identified surface pattern and a candidate surface pattern, if there is a threshold portion of similar characteristics, and the like. In some embodiments, the surface detection engine 225 filters sensor output signals using a low pass filter before performing an FFT operation.

The parameters and factors that the surface detection engine 225 uses to identify the surface pattern of an unknown surface include, but are not limited to: surface expansion joints average length (meters), B; sensor sampling rate (Hz), R; vehicle travel speed (meters/second): S; number of frequency bins, N, vehicle length (meters), L; delay of number of sampling points between the sense of the front wheel and rear wheel of the vehicle, D, defined according to Equation (1).

$$D = \frac{L}{s} * R \qquad ( 1 )$$

The parameters and factors may further include the frequency of the front or the rear wheel hitting surface joints (Hz), f, defined according to Equation (2), and the number of frequency bins, N. The number of frequency bins may be any suitable number of bins (e.g., 1024, 2048).

$$f = \frac{S}{B} \qquad ( 2 )$$

In some embodiments, the upper frequency bound in the frequency domain, or the bandwidth of the sampled signal, is half of the sensor (e.g., accelerometer) sampling rate (Equation 3).

$$BandWidth = \frac{R}{2} \qquad ( 3 )$$

In these embodiments, the frequency domain bin resolution size may be computed according to Equation (4).

$$\frac{B a n d W i d t h}{N} = \frac{R}{2 * N} \qquad ( 4 )$$

The bin index, K, at which the detected peak is expected to be seen is defined

$$K = \frac{f}{\frac{R}{2 * N}} = \frac{S}{B} * \frac{2 * N}{R} \qquad ( 5 )$$

according to Equation (5).

The time domain and frequency domain transformation pairs may be derived according to Equations (6)-(7).

x[n]→X[K] (6)

x[n−D]→e^{-j*φ}*X[K] (7)

In Equation 6, x[n] is the front wheel time domain sampled signal. In Equation (7), x[n−D] is the rear wheel time domain sampled signal. The real-time domain constant time delay/shift corresponds to a constant phase φ rotation in frequency complex domain, defined according to Equation (8).

$$ϕ = \frac{2 * π * K * D}{N} \qquad ( 8 )$$

In both the time and frequency domain, the total effect of a sensed signal is the linear combination of the front wheel signal and the rear wheel signal (Equation 9).

x[n]+x[n−D]→X[K]+e^{-i*φ}*X[K] (9)

The rear wheel delayed signal constant phase φ rotation in the frequency domain can be simplified according to Equation (10).

$$ϕ = \frac{2 * π * \frac{S}{B} * \frac{2 * N}{R} * \frac{L}{S} * R}{N} = 2 * π * \frac{2 * L}{B} = \frac{4 * L * π}{B} \qquad ( 10 )$$

The total effect of sensed signal in the frequency domain is determined by the combined effect of both the front and rear wheel of the vehicle. Due to the phase rotation of the rear wheel, the magnitude of the total effect may be constructively summed or destructively summed based on the actual rotated phase value. For the magnitude to be summed constructively, the phase rotation value should be within a range that does not cause destructive summation. In some embodiments, this occurs when the value of the phase rotation is within a range

$$[ 0 , \frac{2 * π}{3} ] .$$

In other embodiments, the phase rotation range is expanded to include any range whose limits are integer multiples of some critical angle. For example, if the critical angle is

$$\frac{2 * π}{3} ,$$

then the phase rotation range is

$$[ 2 m π , 2 m π + \frac{2 * π}{3} ] ,$$

where m is an integer value. In this example, the surface detection engine 225 may detect a signal peak when the value of the phase rotation is within phase rotation range

$$[ 2 m π , 2 m π + \frac{2 * π}{3} ] .$$

When the phase rotation is within this range, the surface detection engine 225 may identify signal peaks in the sensor output. Based on the pattern of the identified signal peaks, the surface detection engine 225 determines a surface pattern for the signal output.

The surface detection engine 225 may also determine the surface type of a surface using a machine learning model that is configured to predict a surface type. The surface detection engine 225 does this by applying the machine learning model to sensor output signals. The output of the machine learning model may include a probability of a surface type for each of a plurality of surface types, a classification of a surface type, and the like. Alternatively, or additionally, the surface detection engine 225 may also use computer vision models, online learning, and/or reinforcement learning to determine a surface type of an unknown surface.

In some embodiments, the surface detection engine 225 refines the surface type prediction of a surface using information stored in the map store 215. For example, the surface detection engine 225 may identify candidate surface types and candidate surface patterns based on an initial surface type prediction. For example, if the prediction indicates that there is a 50% likelihood a surface is asphalt, a 45% likelihood the surface is paved concrete, and a 5% likelihood the surface is gravel, the surface detection engine may identify asphalt and paved concrete as candidate surface types. The surface detection engine 225 queries a map of an approximate location of the vehicle to identify a set of surface types and candidate surface patterns known to be located at the approximate location of the vehicle. The surface detection engine 225 refines the surface type prediction based on a comparison of the candidate surface types and the set of surface types known to be located at the approximate location of the vehicle. For example, if the set of surface types known to be located at the approximate location of the vehicle includes paved concrete, but does not include asphalt, the surface detection engine 225 may determine the surface type is paved concrete.

The speed detection engine 230 detects the speed of a vehicle using sensor output signals from vehicle sensors 110 and/or user device sensors 120. The speed detection engine 230 may also use vehicle data and time data when determining vehicle speed. For example, the speed detection engine 230 may utilize data corresponding to the vehicle's wheel base, rim size, and time between a front wheel and a back wheel operating over a surface when determining vehicle speed.

In some embodiments, the speed detection engine 230 determines the speed of a vehicle using FFT operations. For example, the speed detection engine 230 may determine the speed of a vehicle using an FFT operation when the surface detection engine 225 determines the surface type of a surface using FFT operations. In these embodiments, the speed detection engine 230 may determine the speed of a vehicle by generating an additional frequency bin that represents the distance between the front wheel of the vehicle and the back wheel of the vehicle. The speed detection engine 230 determines a measurement of time between the front wheel of the vehicle and the back wheel of the vehicle hitting a surface bump. The speed detection engine 230 may then determine the speed of the vehicle based on the additional frequency bin and the measurement of time. In other embodiments, the speed detection engine 230 may determine the speed of a vehicle using machine learning models, computer vision models, and the like. For example, the speed detection engine 230 may determine the speed of the vehicle by inputting imaging data into a trained computer vision model configured to determine vehicle speed based on relative changes of image objects in successive images.

The speed detection engine 230 may also identify if the speed of a vehicle is above or below a speed limit, by how much the vehicle is above or below the speed limit, and the like. For example, the speed detection engine 230 may include a classifier that classifies the speed of a vehicle into one or more categories (e.g., 5 miles per hour (mph) below the speed limit, 5 mph above the speed limit, 10 mph above the speed limit, and the like). Based on the classification, the speed detection engine 230 may determine whether an operator of the vehicle is violating traffic laws of a jurisdiction, whether there are traffic slowdowns, and the like.

The location optimization engine 235 refines the location estimation of a vehicle 105 and/or user device 115. The location optimization engine 235 may do this using a combination of the surface type predictions generated by the surface detection engine 225, location approximations of the vehicle 105 and/or user device 115 (e.g., received from a receiver of the vehicle 105 and/or user device 115), known surfaces of a geographic area corresponding to the location approximation, known locations of surfaces within the geographic area, and the like. In some embodiments, the location optimization engine 235 inputs a combination of this information into a trained positioning model to refine the location approximation of the vehicle 105 and/or user device 115.

In some embodiments, the location optimization engine 235 may refine the location estimation of a vehicle by comparing a predicted surface type with a set of surface types known to be located in a geographic area associated with the location estimation of the vehicle. For example, the location optimization engine 235 may receive a location approximation of a vehicle to identify a geographic area in which the vehicle is located. The location optimization engine 235 identifies 1) surface types within the geographic region, 2) locations of surface within the geographic region, and 3) a surface type of a surface the vehicle is operating on. The location optimization engine 235 may then refine the location of the vehicle based on the surface types within the geographic region, the locations of the surface types within the geographic region, and the identified surface type. For example, the location optimization engine 235 may determine that the vehicle is operating on gravel and that the geographic region of the approximate location of the vehicle includes a gravel walkway adjacent to an asphalt bike lane. Based on the identified surface type and the locations of surface types in the approximate location of the user, the location optimization engine 235 may determine the vehicle is located on the gravel walkway.

The model training engine 245 trains models used by the surface detection engine 225, the speed detection engine 230, and the location optimization engine 235. The model training engine 240 trains the models using training data stored in the model store 220. In some embodiments, to train a machine learning model used by the surface detection engine 225, the model training engine 245 initializes the weights of the machine learning model with an initial set of values. The model training engine 245 applies the machine learning model to the training data to generate surface type predictions. The model training engine 245 updates the weights of the machine learning model based on the surface type predictions and the training data labels. The model training engine 245 may update the weights of the machine learning model iteratively until the performance of the machine learning model at predicting surface types converges with the surface types being predicted. For example, the model training engine 245 may iteratively update the weights of the machine learning model until it correctly predicts a threshold number of surface types, correctly predicts surface types for an above-threshold portion of the training data, minimizes a loss (e.g., a cross-entropy loss, mean square error, etc.), and the like.

The model training engine 245 may similarly train models used by the speed detection engine 230 and the location optimization engine 235. For example, to train a machine learning model used by the speed detection engine 230, the model training engine 245 may update the weights of a machine learning model based on a comparison of the predicted vehicle speeds and actual vehicle speeds indicated in the labels of the training data. Similarly, to train a machine learning model used by the location optimization engine 235, the model training engine 245 may update the weights of the machine learning model based on a comparison of the predicted vehicle locations and actual vehicle locations indicated in the labels of the training data.

The user interface 245 allows users to interact with the surface detection system 130. Through the user interface 245, a user may view rider data, view positioning data, request rider reports, and the like. The user interface 245 may provide interface elements that allow users to modify how elements of the surface detection system 130 are calibrated and tested, configure training schema, select model parameters, and the like.

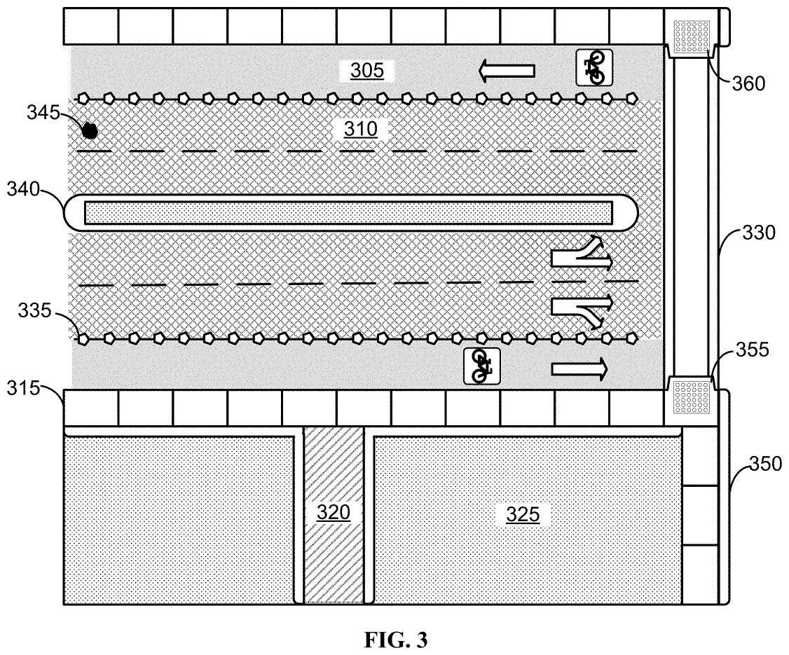

FIG. 3 illustrates the variations in surface types detectable by the surface detection system 130, according to one embodiment. As previously discussed, the types of a surface may be determined based on intended use and/or surface materials. Examples of surface types based on intended use include bike lanes 305, car lanes 310, sidewalks 315, private roads 320, pavilions 325, crosswalks 330, highways, feeder roads, and the like. Examples of surface types based on material type include concrete, asphalt, gravel, packed dirt, grass, cobblestone, brick, pavers, and the like. Further, the surface detection engine 225 may identify street elements. Examples of street elements include lanes, reflectors 335, medians 340, potholes 345, curbs 350, ramps 355, tactile pavements 360, and the like. Based on the determined surface type, the surface detection system 130 may determine whether a user is operating a vehicle below, at, or above a designated speed limit, riding in vehicle-appropriate lanes, stopping at known intersections, entering a crosswalk, merging lanes, passing through a geofence, and the like.

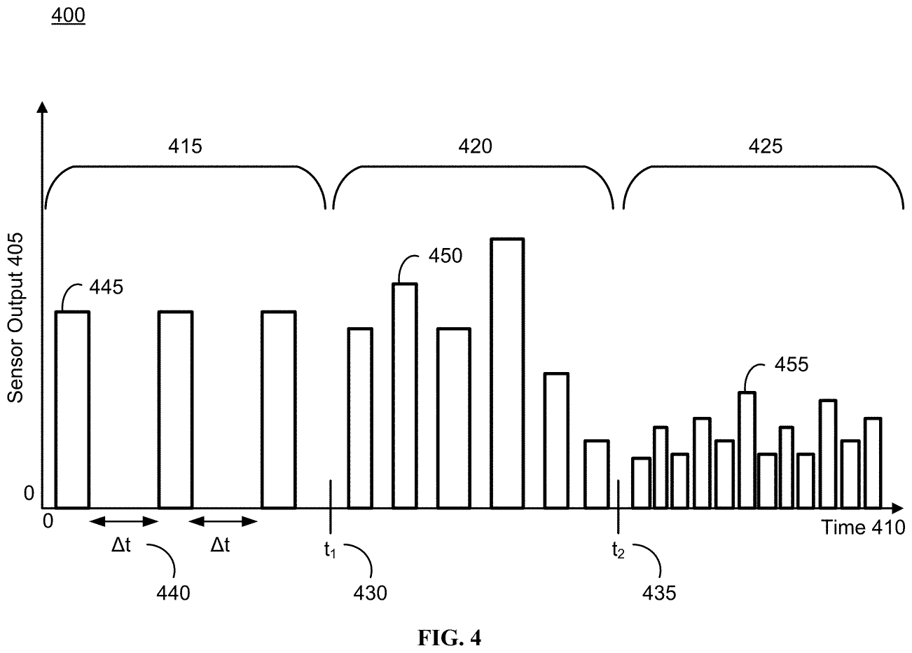

FIG. 4 illustrates a time domain representation 400 of sensor output signals, according to one embodiment. As discussed above, the surface detection engine 225 uses sensor output signals generated over different periods of time to determine a surface type of a surface on which the vehicle is operating. The representation 400 shown includes sensor output signals on the ordinate axis 405 and time on the abscissa axis 410. Other representations may include sensor output signals represented in a frequency domain. In these representations, phase may be presented on the ordinate axis and frequency may be represented on the abscissa axis.

The representation 400 shown includes sensor output signals over three periods of time, namely a first period 415, a second period 420, and a third period 425. The first period 415 corresponds to sensor output signals between time t₀ and time t₁ 430, the second period 420 corresponds to sensor output signals between time t₁ 430 and time t₂ 435, and the third period 425 corresponds to sensor output signals between time t₂ 435 and time t₃ (not shown). The sensor output signals shown have distinct output characteristics in each of the time periods, such that each time period corresponds to a distinct surface pattern. Output characteristics may include amplitude of signal peaks, relativistic amplitude of signal peaks, time between signal peaks, e.g., Δt 440, and the like.

The output characteristics of a time period make up a surface pattern of a surface type. As discussed with reference to FIG. 3, these distinct surface patterns reflect the characteristics of the surface types. For example, in the first period 415, the signal peaks, e.g., peak 445, are of equal magnitude and frequency. This may indicate that a vehicle is operating on a smooth surface with regular grooves, such as a sidewalk made of poured concrete with evenly spaced expansion joints. In the second period 420, the signal peaks, e.g., peak 450, have amplitudes that are generally greater and more sporadic than those in the first period 415. In addition, the signal peaks in the second period 420 are more frequent and have varying durations. This may indicate that the vehicle is operating on a highly irregular surface, such as a tactile pavement or a cobblestone path. In the third period 425, the signal peaks, e.g., peak 455, are smaller, more frequent, and more sporadic than those in the first period 415 and second period 420. This may indicate that the vehicle is operating on a smooth surface such as asphalt, which may have a shallow mean profile depth or low porosity.

Based on the overall profile of the sensor output signals, the surface detection system 130 can make inferences about the user's behavior during vehicle operation. For example, it may be inferred that a user was operating an electric scooter on a sidewalk 315, then rode over a tactile pavement 360 before crossing a crosswalk 330 of an intersection. These inferences may be used to generate rider reports, provide refined location approximations, or generate data for juristic entities to regulate rider behavior.

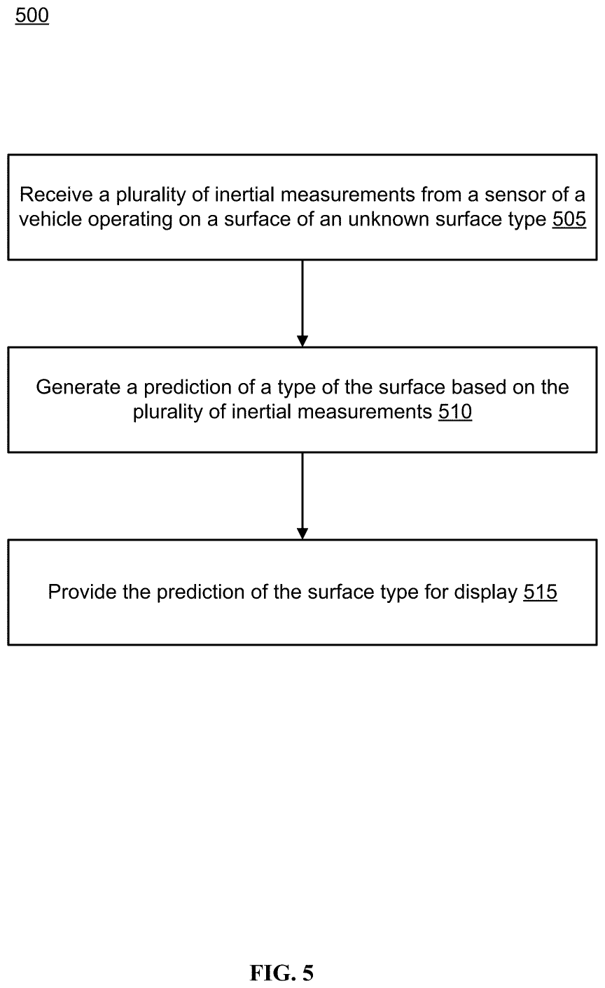

FIG. 5 is a flow chart illustrating an example method 500 of predicting a surface type. In the method 500 shown, the surface detection engine 225 receives 505 a plurality of inertial measurements from a sensor of a vehicle operating on a surface of an unknown surface type. The surface detection engine 225 generates 510 a prediction of a type of surface based on the plurality of inertial measurements. The surface detection engine 225 provides 515 the prediction for display on a user interface 245. In addition, the surface detection engine 225 may determine the speed and/or location of the vehicle based, in part, on the prediction of the type of surface and the inertial measurements.

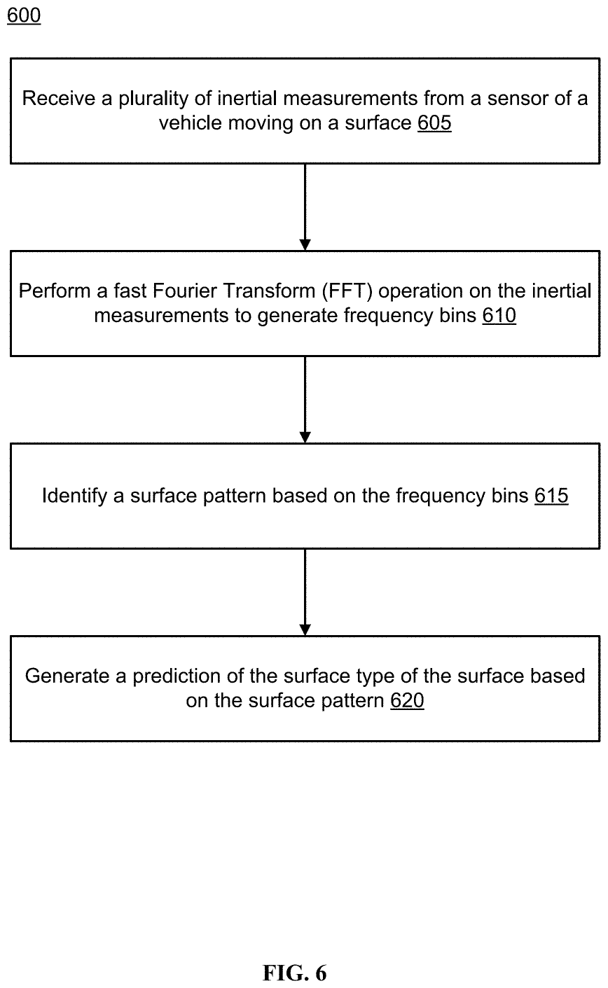

FIG. 6 is flow chart illustrating an example method 600 of determining a surface type of a surface using an FFT operation. In the method 600 shown, surface detection engine 225 receives 605 a plurality of inertial measurements from a sensor of a vehicle moving on a surface of an unknown surface type. The surface detection engine 225 performs 610 an FFT operation on the plurality of inertial measurements to generate one or more frequency bins. The surface detection engine 225 identifies 615 a surface pattern for the surface of the unknown surface type base on the one or more frequency bins. Based on the identified surface pattern, the surface detection engine 225 generates 620 a prediction of the surface type. In some embodiments, the surface detection engine 225 generates 620 the prediction by comparing the surface pattern to one or more candidate surface patterns, each of which includes a label indicating a corresponding surface type. The surface detection engine 225 may compare the surface pattern to the one or more candidate surface patterns by comparing the characteristics of the surface pattern with characteristics of the candidate surface patterns. The surface type of the candidate surface pattern with the most characteristics in common with the surface pattern may be identified as the predicted surface type of the unknown surface.

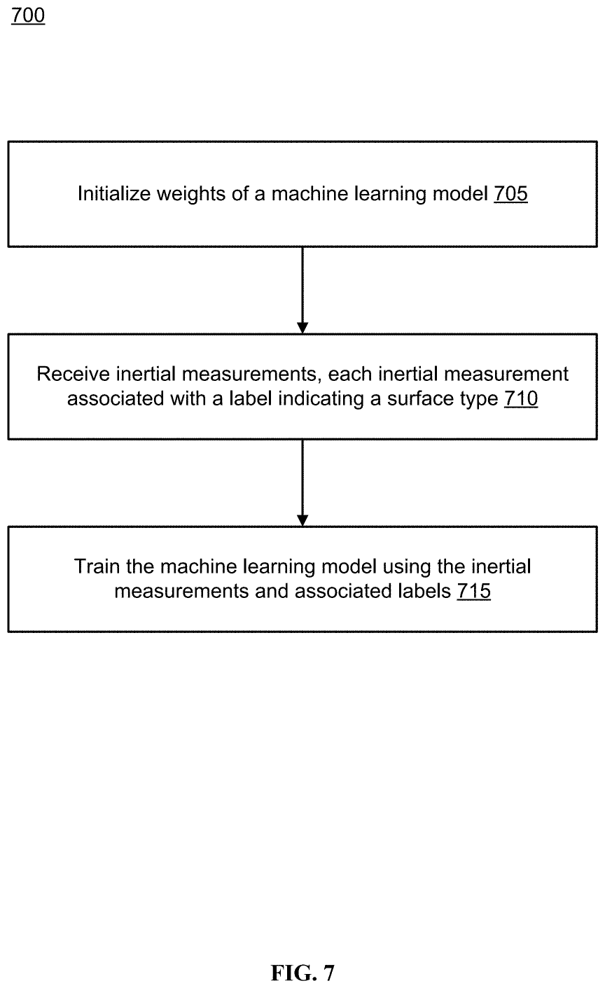

FIG. 7 is a flow chart illustrating an example method 700 of training a machine learning model to predict a surface type. In the method 700 shown, the model training engine 240 initializes 705 the weights of the machine learning model. The model training engine 240 receives 710 a plurality of inertial measurements. Each inertial measurement is associated with a label indicating a surface type. The model training engine 240 trains the machine learning model such that the initialized weights of the machine learning model are updated to improve the predictive ability of the machine learning model to predict a surface type based on a set of inertial measurements.

### CONCLUSION

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may include a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may include information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
receiving, at a surface detection system, a plurality of inertial measurements from a sensor of a vehicle operating on a surface of an unknown surface type;
generating a prediction of a type of the surface based on the plurality of inertial measurements; and
providing for display, on a user device of a user, data representing the prediction of the type of the surface.

2. The method of claim 1, wherein generating the prediction of the type of the surface based on the plurality of inertial measurements comprises:
performing, by the surface detection system, a fast Fourier transform (FFT) operation on the plurality of inertial measurements to generate multiple frequency bins;
identifying a surface pattern based on the generated frequency bins; and
generating the prediction of the type of the surface based on the identified surface pattern.

3. The method of claim 2, further comprising:
determining a speed of the vehicle by:
generating an additional frequency bin, wherein the additional frequency bin represents a distance between a front wheel of the vehicle and a back wheel of a vehicle;
determining a measurement of time between the front wheel of the vehicle hitting a surface bump and the back wheel of the vehicle hitting the surface bump; and
determining the speed of the vehicle based on the additional frequency bin and the measurement of time.

4. The method of claim 1, wherein generating the prediction of the type of the surface based on the plurality of inertial measurements comprises:
applying a machine learning model to the plurality of inertial measurements, the machine learning model configured to generate the prediction of the type of the surface based on the applied plurality of inertial measurements.

5. The method of claim 4, wherein the machine learning model is trained by:
initializing weights of the machine learning model;
receiving a plurality of inertial measurements from a plurality of vehicles, each associated with a label indicating a surface type of a plurality of surface types; and
training the machine learning model using the received plurality of inertial measurements and the associated labels such that the initialized weights of the machine learning model are updated to improve a predictive ability of the machine learning model to predict a surface type based on a set of inertial measurements.

6. The method of claim 1, wherein the prediction of the type of the surface is an initial prediction, and wherein generating the prediction further comprises:
identifying candidate surface types and patterns based on the initial prediction;
querying a map of an approximate location of the vehicle to identify a set of surface types and patterns known to be located within a threshold distance of the approximate location of the vehicle; and
selecting a surface type based on a comparison of the candidate surface types and the identified set of surface types.

7. The method of claim 1, further comprising:
identifying a location of the vehicle based at least in part on the prediction of the type and pattern of the surface.

8. The method of claim 1, further comprising:
generating a rider report for a user of the vehicle based on the prediction of the type and pattern of the surface; and
providing the rider report for display on the user device of the user.

9. The method of claim 1, further comprising:
receiving, from a receiver, an approximate location of the vehicle; and
refining the approximate location of the vehicle based on the prediction of the surface type.

10. A non-transitory computer-readable storage medium containing computer program code that, when executed by a hardware processor, causes the hardware processor to perform steps comprising:
receiving, at a surface detection system, a plurality of inertial measurements from a sensor of a vehicle operating on a surface of an unknown surface type;
generating a prediction of a type of the surface based on the plurality of inertial measurements; and
providing for display, on a user device of a user, data representing the prediction of the type of the surface.

11. The non-transitory computer-readable storage medium of claim 10, wherein generating a prediction of the type of the surface based on the plurality of inertial measurements comprises:
performing, by the surface detection system, a fast Fourier transform (FFT) operation to the plurality of inertial measurements to generate one or more frequency bins;
identifying a surface pattern based on the generated one or more frequency bins; and
generating the prediction of the type of the surface based on the identified surface pattern.

12. The non-transitory computer-readable storage medium of claim 11, wherein the program code, when executed by the hardware processor, causes the hardware processor to perform the steps further comprising:
determining a speed of the vehicle by:
generating an additional frequency bin, wherein the additional frequency bin represents a distance between a front wheel of the vehicle and a back wheel of a vehicle;
determining a measurement of time between the front wheel of the vehicle hitting a surface bump and the back wheel of the vehicle hitting the surface bump; and
determining the speed of the vehicle based on the additional frequency bin and the inertial measurement of time.

13. The non-transitory computer-readable storage medium of claim 10, wherein generating a prediction of the type of the surface based on the plurality of inertial measurements comprises:
applying a machine learning model to the plurality of inertial measurements, the machine learning model configured to generate the prediction of the type of the surface based on the applied plurality of inertial measurements.

14. The non-transitory computer-readable storage medium of claim 13, wherein the machine learning model was trained by:
initializing weights of the machine learning model;
receiving a plurality of inertial measurements from a plurality of vehicles, each associated with a label indicating a surface type of a plurality of surface types; and
training the machine learning model using the received plurality of inertial measurements and the associated labels such that the initialized weights of the machine learning model are updated to improve a predictive ability of the machine learning model to predict a surface type based on a set of inertial measurements.

15. The non-transitory computer-readable storage medium of claim 10, wherein the program code, when executed by the hardware processor, causes the hardware processor to perform the steps further comprising:
receiving, from a receiver, an approximate location of the vehicle; and
refining the approximate location of the vehicle based on the prediction of the surface type.

16. A system comprising
one or more hardware processors; and
a non-transitory computer-readable medium containing instructions that, when executed by the one or more hardware processors, cause the one or more hardware processors to perform steps comprising:
receiving, at a surface detection system, a plurality of inertial measurements from a sensor of a vehicle operating on a surface of an unknown surface type;
generating a prediction of a type of the surface based on the plurality of inertial measurements; and
providing for display, on a user device of a user, data representing the prediction of the type of the surface.

17. The system of claim 16, wherein generating a prediction of the type of the surface based on the plurality of inertial measurements comprises:
performing, by the surface detection system, a fast Fourier transform (FFT) operation to the plurality of inertial measurements to generate one or more frequency bins;
identifying a surface pattern based on the generated one or more frequency bins; and
generating the prediction of the type of the surface based on the identified surface pattern.

18. The system of claim 16, wherein generating a prediction of the type of the surface based on the plurality of inertial measurements comprises:
applying a machine learning model to the plurality of inertial measurements, the machine learning model configured to generate the prediction of the type of the surface based on the applied plurality of inertial measurements.

19. The system of claim 18, wherein the machine learning model was trained by:
initializing weights of the machine learning model;
receiving a plurality of inertial measurements from a plurality of vehicles, each associated with a label indicating a surface type of a plurality of surface types; and
training the machine learning model using the received plurality of inertial measurements and the associated labels such that the initialized weights of the machine learning model are updated to improve a predictive ability of the machine learning model to predict a surface type based on a set of inertial measurements.

20. The system of claim 16, containing instructions that cause the one or more hardware processors perform steps further comprising:
receiving, from a receiver, an approximate location of the vehicle; and
refining the approximate location of the vehicle based on the prediction of the surface type.
